(19) United States
(12) Patent Application Publication
(10) Pub. No.: US 2016/0238704 A1
(43) Pub. Date: Aug. 18, 2016

(54) SATELLITE GEODESY AND RESERVOIR PERFORMANCE

(71) Applicant: CONOCOPHILLIPS COMPANY, Houston, TX (US)

(72) Inventors: Richard A. SCHULTZ, Houston, TX (US); Khalid A. SOOFI, Houston, TX (US); Peter H. HENNINGS, Houston, TX (US)

(21) Appl. No.: 14/945,933

(22) Filed: Nov. 19, 2015

Related U.S. Application Data
(60) Provisional application No. 62/081,945, filed on Nov. 19, 2014.

(51) Int. Cl. G01S 13/90; E21B 49/00

(52) U.S. Cl. CPC G01S 13/9023; E21B 49/00

(57) ABSTRACT

Satellite geodesy can identify fault-related surface deformation above onshore oil and gas fields through the use of radar interferometry (InSAR). The method provides an independent and cost-effective approach to identifying faults and damage zones that can be associated with increased reservoir performance beyond traditional tools of subsurface imaging and reservoir evaluation.

### PRIORITY CLAIM

This application is a non-provisional application which claims benefit under 35 USC §119(e) to U.S. Provisional Application Ser. No. 62/081,945 filed Nov. 19, 2014, entitled “SATELLITE GEODESY AND RESERVOIR PERFORMANCE,” which is incorporated herein in its entirety.

### FIELD OF THE INVENTION

The present invention relates generally to remote sensing of subterranean formations. More particularly, but not by way of limitation, embodiments of the present invention include tools and methods for assessing oil and gas reservoirs using radar interferometry.

### BACKGROUND OF THE INVENTION

Traditionally, oil and gas reservoirs have been characterized by using subsurface engineering methods. Improving oil and gas reservoir performance has relied on data obtained by subsurface methods that feature, for example, wellbore geomechanics, sonic logs, and seismic interpretation of subsurface reflectors. These subsurface methods often require delicate and expensive equipment collecting computationally intensive data. Currently, there are limited number of non-subsurface analytical methods that can independently, conveniently, and cost-effectively assess reservoirs for exploration, production, and/or containment evaluation purposes.

Radar interferometry or interferometric synthetic aperture radar (InSAR) is a specialized radar technique used to measure Earth's surface deformations remotely from above the Earth's surface (e.g., Bürgmann and Thatcher, 2013). InSAR uses phase interferometer methods between two spatially displaced high resolution synthetic aperture radar (SAR) images to generate high quality terrain elevation maps. Deformations small as centimeter-scale can be detected by comparing time-lapsed satellite SAR images. The satellite images may be taken, for example, a few days apart to a few years apart. Radar interferometry has been used primarily to monitor natural hazards such as earthquakes, volcanoes and landslides. Radar interferometry has seen some use in oil and gas applications such as production monitoring in heavy oil fields (Stancliffe and van der Wooij, 2001; Gu et al., 2011; Teatini et al., 2011; Khakim et al., 2012) but has not yet been fully realized for subsurface faults within oil and gas fields.

### BRIEF SUMMARY OF THE DISCLOSURE

The present invention relates generally to remote sensing of subterranean formations. More particularly, but not by way of limitation, embodiments of the present invention include tools and methods for assessing oil and gas reservoirs using radar interferometry.

One example of a method for assessing an onshore hydrocarbon reservoir, includes: a) obtaining a plurality of synthetic aperture radar images of the Earth's surface; b) identifying and acquiring synthetic aperture radar images covering the onshore hydrocarbon reservoir; c) assessing technical characteristic of the radar images, the technical characteristic selected from the group consisting of: look direction, baseline, temporal coherence, correlation, degree and direction of overlap, spatial resolution, desired temporal coverage, and any combination thereof; d) constructing an interferogram showing ground motion over a selected time interval; e) determining one or more deformations of the Earth's surface, wherein the one or more deformations are near or on the onshore hydrocarbon reservoir; f) identifying a fault in the Earth's subsurface, wherein the fault provides leakage path for a subsurface fluid; g) interpreting magnitude and pattern of ground motion that indicate currently or recently active displacement along the fault at the Earth's surface; h) correlating interpreted magnitude and pattern of ground motion with independent surface or subsurface data; i) using the interferogram to identify currently or recently active fault to augment or test subsurface data and interpretation regarding reservoir performance; j) revising one or more operational parameters related to hydrocarbon recovery; and k) recovering the hydrocarbon from the leakage path by using drilling, completion, or reservoir engineering techniques.

Another example of a method for assessing an onshore reservoir, includes: a) obtaining synthetic aperture radar images covering at least a portion of the onshore reservoir; b) identifying one or more deformations of a selected area, wherein the one or more deformations are near or on the onshore reservoir; c) analyzing ground motions in the selected area to identify currently or recently active displacement along a fault on or near the onshore reservoir; d) comparing analyzed ground motions with independent surface or subsurface data; and e) revising one or more operational parameters related to subsurface fluid recovery.

Yet another example of a method for assessing an onshore hydrocarbon reservoir, includes: a) acquiring synthetic aperture radar images of the onshore hydrocarbon reservoir; b) constructing an interferogram based on the synthetic aperture radar images; c) determining one or more deformations of the Earth's surface from the interferogram, wherein the one or more deformations are near or on the onshore hydrocarbon reservoir; d) identifying a fault in the Earth's subsurface, wherein the fault provides leakage path for a subsurface fluid; e) interpreting magnitude and pattern of ground motion that indicate currently or recently active displacement along the fault at the Earth's surface; f) correlating interpreted magnitude and pattern of ground motion with independent surface or subsurface data; g) using the interferogram to identify currently or recently active fault to augment or test subsurface data and interpretation regarding reservoir performance; and h) revising one or more operational parameters related to hydrocarbon recovery.

### BRIEF DESCRIPTION OF THE DRAWINGS

A more complete understanding of the present invention and benefits thereof may be acquired by referring to the following description taken in conjunction with the accompanying drawings in which:

FIGS. 1A-1C illustrate an embodiment of the present invention as described in the Example.

FIGS. 2A-2D illustrate embodiment of the present invention as described in the Example.

### DETAILED DESCRIPTION

Reference will now be made in detail to embodiments of the invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations that come within the scope of the invention.

One of the goals of the present invention is to extend the use of radar interferometry for oil and gas applications involving subsurface faults. While radar interferometry is a mature technique, it has not yet been fully realized for oil and gas applications involving subsurface faults. The present invention provides tools and methods for assessing oil and gas reservoirs by identifying active fault-related deformations in or near onshore oil and gas fields using radar interferometry. It is believed and becoming more widely recognized that a relationship exists between stress state, stress heterogeneity, and permeability of subsurface fractures and faults. In other words, these fault-related deformations can significantly alter geophysical properties of a reservoir, which in turn, can impact oil field strategies and decisions on how to locate and safely maximize retrieval of hydrocarbons.

Many oil and gas reservoirs are located in tectonically quiet continental interiors or in passive continental margins offshore. Other oil and gas reservoirs may be located onshore in or near tectonically active areas such as subduction zones where two tectonic plates come together, one riding over the other, causing one plate to sink into the mantle as the tectonic plates converge. Typically, rate of convergence can range from about 2 to 8 cm per year. A geological fault can compartmentalize oil and gas reservoir and its trapped hydrocarbon, providing a leakage path for subsurface fluids during, for example, production or wastewater disposal operations. Geological faults in tectonically active areas (such as near subduction zones) can be critically stressed, leading to increased productivity where wells intersect faults and damage zones. Radar interferometry can be particularly useful in identifying areas of enhanced reservoir performance and in guiding efforts to improve production.

As used herein, the term “critically stressed” refers to a fracture that is favorably oriented to fail in shear under a stress field. A critically stressed fracture may be inferred from a variety of factors including, but not limited to, wellbores, seismically-interpreted stratigraphic offsets, as well as other subsurface data. As used herein, “fault” is a plane of detachment (e.g., a fracture or discontinuity) in a volume of rock, across which there has been significant displacement along the plane of detachment resulting from earth movement. The term “deformation” refers to a change in shape or volume caused by applied stress.

As used herein, “damage zone” refers to volume of deformed wall rocks around a fault surface. Typically, damage zone results from initiation, propagation, interaction and build-up of slip along faults.

### Radar Interferometry

Radar interferometry (sometimes referred to as “interferometric synthetic aperture radar” or “InSAR” or “SAR”) is a well-known technique that uses multiple images (2 or more) to generate maps of surface deformation or digital terrain based on differences in phase of waves returning to a satellite or aircraft. Thus, SAR provides a remote sensing technology that produces accurate land surface elevation change measurements. Since SAR is based on sensing reflections of electromagnetic waves, the radar can be operated day and night and even through cloudy conditions. Radar interferometry can also be cost-effective especially when compared to conventional subsurface methods. Other advantages will be apparent from the disclosure herein.

In principle, an SAR system transmits an electromagnetic signal and measures magnitude and phase of the signal backscattered from the earth's surface. Magnitude is generally affected by properties of the surface. Phase is an indication of the distance between the SAR system and surface and surface scattering effect on the incident electromagnetic wave. Changes to the surface can be observed by taking a second SAR data set collected from the same or nearly same location in space as the first image and subtracting the phase of the second image from the first image, which generates an interferogram. This process can be used to monitor ground deformations associated with active faulting, ground water withdrawal and recharge, and volcano inflation and hazards. Moreover, extraction of oil can cause volume reduction or increase of the subsurface, which in turn is manifested by subsidence or uplift at surface.

In accordance with the present invention, radar interferometry can be used to identify occurrence of critically stressed or active faults in the subsurface to potentially identify areas of enhanced reservoir performance and guide efforts to improve production. A number of challenges have prevented the widespread use of radar interferometry in oil and gas industry involving subsurface faults. For one, radar interferometry in oil and gas applications has generally focused on reservoirs that are located in tectonically quiet continental interiors or in passive continental margins (e.g., Gu et al., 2011; Khakim et al., 2012). Furthermore, there is technical challenge of integrating or complementing radar interferometry data with subsurface data to, for example, locate potentially rich reservoirs, increase production, as well as address safety issues surrounding tectonically active areas.

In some embodiments, radar images can be assessed for technical characteristics. Examples of technical characteristic include, but are not limited to, look direction, baseline, temporal coherence, correlation, degree and direction of overlap, spatial resolution, desired temporal coverage, and any combination thereof;

The present invention extends the use of radar interferometry to oil and gas fields located in tectonically active areas and involving subsurface faults, which in turn can be used to provide novel and valuable insights that can be used to make oil field decisions related to exploration, production, and/or containment. Moreover, data obtained from radar interferometry may be compared with subsurface data to provide independent confirmation or to improve quality of reservoir assessment. Conventional subsurface methods typically do not provide time-lapsed deformation changes.

### EXAMPLE

This Example describes an embodiment of the present invention as applied to an oil and gas producing field, Suban field located in Sumatra, Indonesia (e.g., Schultz et al., 2014a, b). Synthetic aperture radar data were obtained from the Advanced Land Observing Satellite (ALOS) via an L-band (23.6 cm wavelength) radar which provides good temporal coherence for constructing interferograms. Twenty-six obtained raw images (19 ascending and 7 descending acquisitions) were used to perform an interferometry analysis (e.g., Soofi and Sandwell, 2010; Tong et al., 2013).

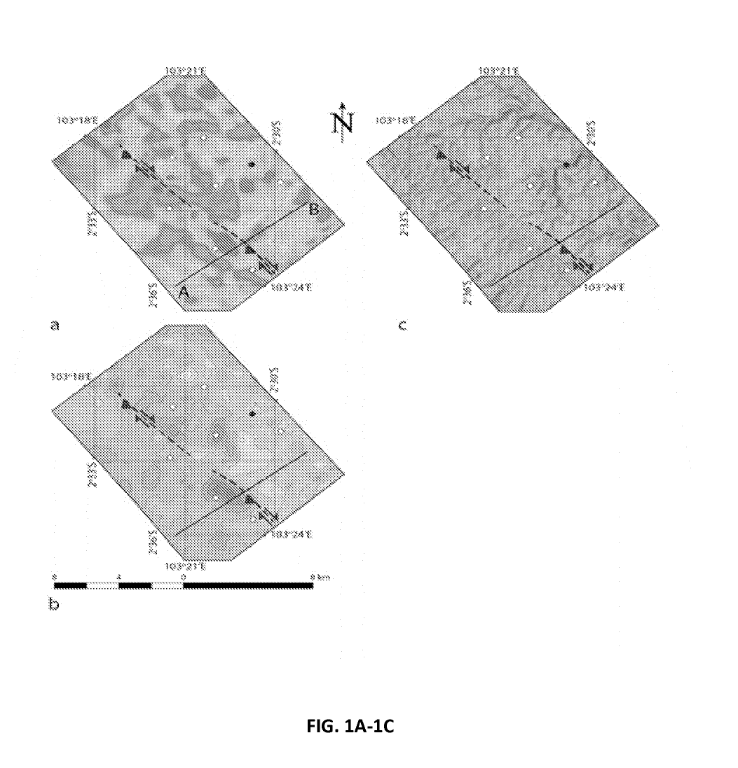

During the interferometry analysis, raw binary radar images were pre-processed and focused to form full-resolution SAR images. All SAR images were aligned to a single image with 2D cross-correlation techniques. Typically, the image alignment needs to be accurate within ˜1 pixel (˜10 m) in order to construct the interferograms. During this process, phase due topography was removed and the residual phase was unwrapped (e.g., Chen and Zebker, 2000). These unwrapped phase maps were then individually filtered with a high-pass Gaussian filter and stacked to yield an average line-of-sight (LOS) velocity map (FIG. 1A-1D). The filtering step reduces error sources associated with any ground motion greater than 20 km wavelength. Standard deviation of the LOS velocity was calculated to evaluate the uncertainties caused by various error sources such as clouds in the troposphere, ionosphere delay, inaccurate orbital ephemeris, and unwrapping errors. Standard deviations of the velocity map range from 0 to 100 mm/yr with a mean of 12±10 mm/yr. This error reflects the location of Suban field in a highly vegetated tropical area. Areas in the LOS velocity map with large noise (standard deviation>20 mm/yr) were masked out. The final stacked and masked LOS velocity map ranged from approximately ˜23 to 33 mm/yr with a standard deviation of ˜1 mm/yr. The InSAR results suggest that uplift and horizontal contractional motions occurred along what might be interpreted from subsurface data as the projection into the near-surface of one or more of the major right-oblique bounding fault in the southwestern part of the Suban field. Three areas of subsidence, as much as about 5 mm/yr over that interval, were also identified over Suban field.

The pattern of uplift rate across the bounding fault is consistent with the deformation of the ground surface above blind reverse or thrust faults in other contractional tectonic settings (e.g., King et al., 1988; Ma and Kusznir, 1993; Cohen, 1999; Okubo and Schultz, 2004; Schultz, 2011). The pattern of uplift generally correlates with contemporary topography as shown by SW to NE transect. The similarity of uplift and topography along the transect implies that the current topography across this part of Suban field is related at least in part to reverse offsets along the subjacent faults and related deformation. Results obtained from the method are consistent with inferences made by Hennings et al. (2012) on basis of wellbore and other subsurface data that the faults were active and related to subduction tectonics across Sumatra.

Referring to FIGS. 1A-1B, vertical (FIG. 1A) and horizontal (FIG. 1B) velocity maps were obtained from the InSAR analysis. Contours are at 5 mm/yr interval while the dashed line is approximate position of inferred surface trace of the SW right-oblique fault. FIG. 1C shows shuttle radar topography mission (SRTM) map of the region illustrated in FIGS. 1A-1B. Structure contours of Suban reservoir top at depth correspond approximately to top of the pre-Tertiary units with local highs in warm colors. As shown in FIG. 1C, increased values of vertical velocity change (uplift) and horizontal velocity change (shortening) along SW oblique-slip fault. Location of a profile (labelled “A-B”) is shown by solid line on FIGS. 1A-1C. In these figures, white dots represent gas wells while black dot represent oil well.

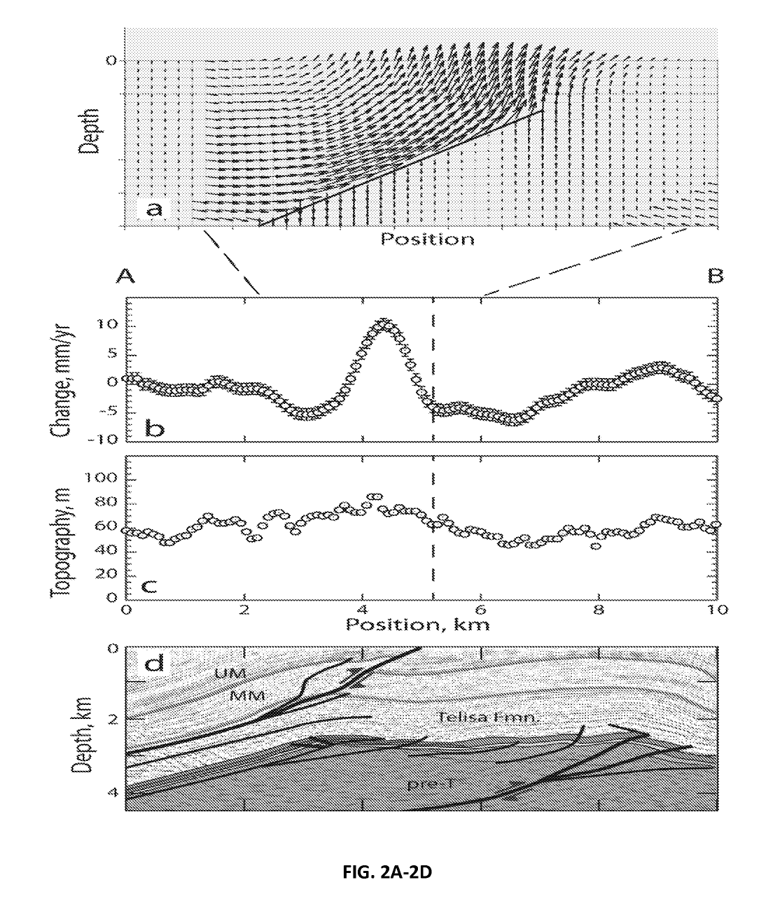

FIG. 2A illustrates deformation associated with reverse or thrust faulting calculated by using the COULOMB three-dimensional forward mechanical dislocation program. Arrows are local displacement vectors showing rock displacements associated with the fault slip. FIG. 2B shows comparison between InSAR vertical velocity change (positive values, uplift; negative, subsidence). FIG. 2C show surface elevation from SRTM digital elevation model. FIG. 2D show geologic section across part of Suban field, part of section line A-A′ shown on FIG. 1. Location of profile A-B shown on FIGS. 1A-1C.

In closing, it should be noted that the discussion of any reference is not an admission that it is prior art to the present invention, especially any reference that may have a publication date after the priority date of this application. At the same time, each and every claim below is hereby incorporated into this detailed description or specification as additional embodiments of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

### REFERENCES

All of the references cited herein are expressly incorporated by reference. The discussion of any reference is not an admission that it is prior art to the present invention, especially any reference that may have a publication data after the priority date of this application. Incorporated references are listed again here for convenience:
Bürgmann, R., and Thatcher, W., 2013, Space Geodesy—A Revolution in Crustal

Deformation Measurements of Tectonic Processes, in Bickford, M. E., ed., The Web of Geological Sciences: Advances, Impacts, and Interactions: Geological Society of America Special Paper 500, p. 397-430.
Chen, C. W. and H. A. Zebker, 2000, Network approaches to two-dimensional phase unwrapping: Intractability and two new algorithms: Journal of the Optical Society of America, 17, 401-414, doi:10.1364/JOSAA.17.000401.
Cohen, S. C., 1999, Numerical models of crustal deformation in seismic zones: Advances in Geophysics, 41, 133-231.
Gu, F., M. Chan and R. Fryk, 2011, Geomechanical-data acquisition, monitoring, and applications in SAGD: Journal of Canadian Petroleum Technology, 50, 9-21.
Hennings, P., P. Allwardt, P. Paul, C. Zahm, R. Reid, Jr., H. Alley, R. Kirschner, B. Lee and E. Hough, 2012, Relationship between fractures, fault zones, stress, and reservoir productivity in the Suban gas field, Sumatra, Indonesia: American Association of Petroleum Geologists Bulletin, 96, 753-772.
Khakim, M. Y. N., T. Tsuji and T. Matsuoka, 2012, Geomechanical modeling for InSAR-derived surface deformation at steam-injection oil sand fields: Journal of Petroleum Science and Engineering, 96-97, 152-161.
King, G. C. P., R. S. Stein and J. B. Rundle, 1988, The growth of geological structures by repeated earthquakes, 1, Conceptual framework: Journal of Geophysical Research, 93, 13,307-13,318.
Ma, X. Q. and N. J. Kusznir, 1993, Modelling of near-field subsurface displacements for generalized faults and fault arrays: Journal of Structural Geology, 15, 1471-1484.
Okubo, C. H. and R. A. Schultz, 2004, Mechanical stratigraphy in the western equatorial region of Mars based on thrust fault-related fold topography and implications for near-surface volatile reservoirs: Geological Society of America Bulletin, 116, 594-605.
Schultz, R. A., 2011, Relationship of compaction bands in Utah to Laramide fault-related folding: Earth and Planetary Science Letters, 304, 29-35.
Schultz, R. A., X. Tong, K. A. Soofi, D. T. Sandwell and P. H. Hennings, 2014a, Satellite interferometry and the detection of active deformation associated with faults in Suban field, South Sumatra Basin, Indonesia: Proceedings, Indonesian Petroleum Association, 38^{th} Annual Convention and Exhibition, Jakarta, Indonesia, May 21-23, 2014, paper IPA14-G-068.
Schultz, R. A., X. Tong, K. A. Soofi, D. T. Sandwell, and P. H. Hennings, 2014b, Using InSAR to detect active deformation associated with faults in Suban field, South Sumatra Basin, Indonesia: The Leading Edge, 33, 882-888.
Soofi, K. A. and D. Sandwell, 2010, Long time span interferograms and effects of snow cover on interferometric phase at L/C-bands: poster presented at the 4^{th} Joint PI Symposium of ALOS Data Nodes for ALOS Science Program, Nov. 15-18, 2010, Tokyo, Japan.
Stancliffe, R. P. W. and M. W. A. van der Wooij, 2001, The use of satellite-based radar interferometry to monitor production activity at the Cold Lake heavy oil field, Alberta, Canada: American Association of Petroleum Geologists Bulletin, 85, 781-793.
Teatini, P., G. Gambolati, M. Ferronato, A. Settari, and D. Walters, 2011, Land uplift due to subsurface fluid injection: Journal of Geodynamics, 51, 1-16.
Tong, X., D. T. Sandwell and B. Smith-Konter, 2013, High-resolution interseismic velocity data along the San Andreas Fault from GPS and InSAR: Journal of Geophysical Research, 118, doi 10.1029/2012JB009442.

1. A method for assessing an onshore hydrocarbon reservoir, comprising:
a. obtaining a plurality of synthetic aperture radar images of the Earth's surface;
b. identifying and acquiring synthetic aperture radar images covering the onshore hydrocarbon reservoir;
c. assessing technical characteristic of the radar images, the technical characteristic selected from the group consisting of: look direction, baseline, temporal coherence, correlation, degree and direction of overlap, spatial resolution, desired temporal coverage, and any combination thereof;
d. constructing an interferogram showing ground motion over a selected time interval;
e. determining one or more deformations of the Earth's surface, wherein the one or more deformations are near or on the onshore hydrocarbon reservoir;
f. identifying a fault in the Earth's subsurface, wherein the fault provides leakage path for a subsurface fluid;
g. interpreting magnitude and pattern of ground motion that indicate currently or recently active displacement along the fault at the Earth's surface;
h. correlating interpreted magnitude and pattern of ground motion with independent surface or subsurface data;
i. using the interferogram to identify currently or recently active fault to augment or test subsurface data and interpretation regarding reservoir performance;
j. revising one or more operational parameters related to hydrocarbon recovery; and
k. recovering the hydrocarbon from the leakage path by using drilling, completion, or reservoir engineering techniques.

2. The method of claim 1, wherein the Earth's surface is near a subduction zone.

3. The method of claim 1, wherein the radar images are obtained using radar interferometry.

4. The method of claim 1, wherein the subsurface fluid is selected from the group consisting of: oil, gas, water, and any combination thereof.

5. The method of claim 1, wherein the plurality of synthetic aperture radar images are taken at time-lapse intervals.

6. The method of claim 5, wherein the time-lapse intervals range between about 1 day to about 10 years.

7. The method of claim 1, wherein the oil and reservoir is faulted or critically stressed.

8. A method for assessing an onshore reservoir, the method comprising:
a. obtaining synthetic aperture radar images covering at least a portion of the onshore reservoir;
b. identifying one or more deformations of a selected area, wherein the one or more deformations are near or on the onshore reservoir;
c. analyzing ground motions in the selected area to identify currently or recently active displacement along a fault on or near the onshore reservoir;
d. comparing analyzed ground motions with independent surface or subsurface data; and
e. revising one or more operational parameters related to subsurface fluid recovery.

9. The method of claim 8, wherein the radar images are obtained using radar interferometry.

10. The method of claim 8, wherein the subsurface fluid is selected from the group consisting of: oil, gas, water, and any combination thereof.

11. The method of claim 8, wherein the synthetic aperture radar images are taken at time-lapse intervals.

12. The method of claim 11, wherein the time-lapse intervals range between about 1 day to about 10 years.

13. The method of claim 8, wherein the reservoir is faulted or critically stressed.

14. A method for assessing an onshore hydrocarbon reservoir, comprising:
a. acquiring synthetic aperture radar images of the onshore hydrocarbon reservoir;
b. constructing an interferogram based on the synthetic aperture radar images;
c. determining one or more deformations of the Earth's surface from the interferogram, wherein the one or more deformations are near or on the onshore hydrocarbon reservoir;
d. identifying a fault in the Earth's subsurface, wherein the fault provides leakage path for a subsurface fluid;
e. interpreting magnitude and pattern of ground motion that indicate currently or recently active displacement along the fault at the Earth's surface;
f. correlating interpreted magnitude and pattern of ground motion with independent surface or subsurface data;
g. using the interferogram to identify currently or recently active fault to augment or test subsurface data and interpretation regarding reservoir performance; and
h. revising one or more operational parameters related to hydrocarbon recovery.

15. The method of claim 14, further comprising:
recovering the hydrocarbon from the leakage path by using drilling, completion, or reservoir engineering techniques.

16. The method of claim 14, wherein the Earth's surface is near a subduction zone.

17. The method of claim 14, wherein the radar images are obtained using radar interferometry.

18. The method of claim 14, wherein the synthetic aperture radar images are taken at time-lapse intervals.

19. The method of claim 14, wherein the time-lapse intervals range between about 1 day to about 10 years.

20. The method of claim 14, wherein the reservoir is faulted or critically stressed.
